(19) United States
(12) Patent Application Publication
(10) Pub. No.: US 2020/0201337 A1
(43) Pub. Date: Jun. 25, 2020

(54) ANTI-DROP-OFF SYSTEM FOR ROBOT

(71) Applicant: Jason Yan, New Taipei City (TW)

(72) Inventor: Jason Yan, New Taipei City (TW)

(21) Appl. No.: 16/286,107

(22) Filed: Feb. 26, 2019

(30) Foreign Application Priority Data
Dec. 20, 2018 (TW) 107146093

(51) Int. Cl. G05D 1/02; B25J 9/16

(52) U.S. Cl. CPC G05D 1/0214; B25J 11/0085; B25J 9/162; B25J 9/1676

(57) ABSTRACT

An anti-drop-off system for robot is provided, which mainly includes a detection unit, a control unit, a driving unit, a first determination and a first switching unit. The detection unit generates an anti-drop-off precaution signal when detecting that the robot will drop off if the robot keeps moving in the moving direction thereof. The control unit receives the anti-drop-off precaution signal and then transmits a moving control signal to the driving unit. If receiving the anti-drop-off precaution signal and the moving control signal, the first determination unit transmits a first interrupt signal to the first switching unit and further stops the control unit transmitting the moving control signal for controlling the robot to move in the direction which the robot will drop off to the driving unit in order to make real-time determination and prevent the robot from dropping off

### BACKGROUND OF THE INVENTION

### 1. Field of the Invention

The present invention relates to an anti-drop-off system for robot, in particular to an anti-drop-off system for robot capable of swiftly determining the anti-drop-off precaution signal and preventing the robot from dropping off via another independent circuit when the control unit malfunctions.

### 2. Description of the Prior Art

Robot cleaners are becoming more and more popular in order to conveniently clean the houses of families, which can automatically move within a predetermined area to suck up dust or foreign objects in order to clean the area. In general, robot cleaners are usually provided with relevant detectors, which can not only detect whether there are obstacles in the cleaning paths, but also can detect the ground to avoid the robot cleaners drop off from the ground.

In order to realize the anti-drop-off technology, the prior art usually use a conventional robot cleaner usually detects the ground via a detection unit and uses a control unit to drive a driving unit to move. When the detection unit detects the that the distance increases, the detection unit determines that there is a height difference between the ground and the robot cleaner and the robot cleaner may drop off from the ground. Then, the detection unit generates an anti-drop-off precaution signal to the control unit, such that the control unit stops controlling the driving unit to move.

However, the control unit may not immediately detect the anti-drop-off precaution signal if only the control unit is used to perform the above operation. In other words, the robot cleaner may drop off from the ground before the control unit detects the anti-drop-off precaution signal. Besides, if the control unit malfunctions, the anti-drop-off precaution signal transmitted from the detection unit cannot effectively avoid that the robot cleaner drops off from the ground. Thus, it has become an important issue to swiftly detect the anti-drop-off precaution signal and avoid the situation that the control unit cannot prevent the robot cleaner drop off because malfunctioning.

### SUMMARY OF THE INVENTION

To achieve the foregoing objective, the present invention provides an anti-drop-off system for robot, which is an independent determination circuit connected to a control unit. After the system determines that the robot will drop off if the robot keeps moving in the moving direction via a detection unit, the system can implement the corresponding operations via the control unit and a first determination unit in order to drive the robot to stop moving or move in the direction contrary to the original moving direction. Therefore, the system can effectively solve the problems of prior art.

The present invention provides an anti-drop-off system for robot, which includes:

A driving unit; the driving unit is disposed inside a robot to drive the robot to move.

A detection unit; the direction unit is disposed at one or both of the bottom and the peripheral of the robot. The detection unit transmits a detection signal. The detection signal is that the detection unit generates an anti-drop-off precaution signal when detecting the robot is going to drop off in the moving direction thereof.

A control unit; the control unit is disposed inside the robot, connected to the detection unit and the driving unit. The control unit transmits a moving control signal to the driving unit to control the driving unit to drive the robot to move. When the control unit receives the anti-drop-off precaution signal, the control unit transmits an anti-drop-off control signal to the driving unit;

A first determination unit; the first determination is disposed inside the robot and connected to the detection unit and the control unit. When receiving the anti-drop-off precaution signal and the moving control signal for controlling the robot to move in the direction which the robot will drop off, the first determination transmits a first interrupt signal.

A first switching unit; the first switching is disposed inside the robot, between the control unit and the driving unit and connected to the first determination unit. When receiving the first interrupt signal, the first switching unit stops the control unit transmitting the moving control signal which drives the robot to move in the direction which the robot will drop off to the driving unit.

Preferably, the moving control signal is a move-forward signal for driving the robot to move forward and the detection unit is disposed in front of the robot. The anti-drop-off precaution signal is move-forward anti-drop-off precaution signal for preventing the robot moving forward and then dropping off When receiving the move-forward anti-drop-off signal, the control unit stops transmitting the move-forward signal and then transmitting the moving control signal to the robot again. The moving control signal is changed to be a move-backward signal for driving the robot to move backward.

Preferably, the moving control signal is a move-backward signal for driving the robot to move backward and the detection unit is disposed behind the robot. The anti-drop-off precaution signal is move-backward anti-drop-off precaution signal for preventing the robot moving backward and then dropping off. When receiving the move-backward anti-drop-off signal, the control unit stops transmitting the move-backward signal and then transmitting the moving control signal to the robot again. The moving control signal is changed to be a move-forward signal for driving the robot to move forward.

Preferably, the anti-drop-off system further includes:

A second determination unit; the second determination is connected to the driving unit and the control unit. When receiving a moving direction of the driving unit and the moving direction of the driving unit is different from the moving direction of the moving control signal, the second determination unit transmits a second interrupt signal.

A second switching unit; the driving unit is connected to a power supply unit disposed in the robot via the second switching unit, and the second switching unit is further connected to the second determination unit. When receiving the second interrupt signal, the second switching unit disconnects the driving unit from the power supply unit.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a schematic view of a move-forward detection status of an anti-drop-off system in accordance with the present invention.

FIG. 2 is a system connection relation diagram of the anti-drop-off system in accordance with the present invention.

FIG. 3 is a control circuit diagram of the anti-drop-off system in accordance with the present invention.

FIG. 4 is a schematic view of a move-backward detection status of the anti-drop-off system in accordance with the present invention.

FIG. 5 is a system connection relation diagram of moving direction determination of the anti-drop-off system in accordance with the present invention.

### DETAILED DESCRIPTION OF THE PREFERRED EMBODIMENT

The following description is about embodiments of the present invention; however it is not intended to limit the scope of the present invention.

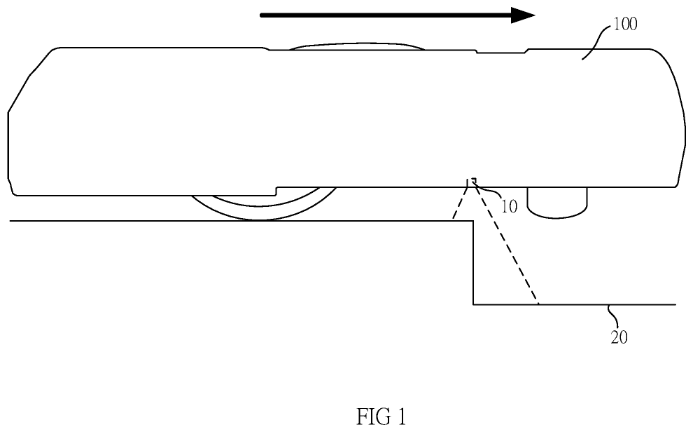

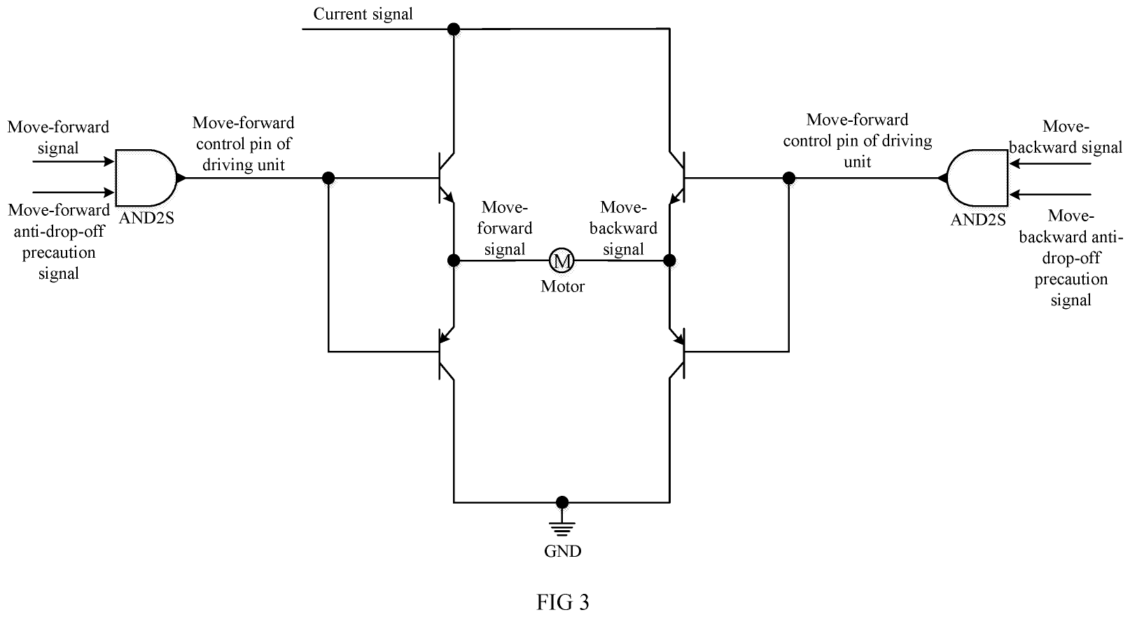

Please refer to FIG. 1 to FIG. 4, which are a schematic view of a move-forward detection status, a system connection relation diagram, a control circuit diagram and a schematic view of a move-backward detection status of an anti-drop-off system in accordance with the present invention. As shown in FIG. 1 to FIG. 4, the anti-drop-off system of the present invention includes a detection unit 10 disposed at the chassis of a robot 100. The detection unit 10 detects a ground 20 for the robot 100 in order to determine whether the robot 100 will drop off from the ground 20 in the moving direction. In this way, if the detection signal 11 shows the distance increases or the detection unit 100 cannot receive the return signal after transmitting the detection signal 11, the detection unit 10 generates an anti-drop-off precaution signal 12.

Besides, the robot 100 is driven by a driving unit 30, so the robot 100 can move forward or move backward. More specifically, the driving unit 30 is connected to a control unit 40; the control unit 40 transmits a moving control signal 41 to the driving unit 30; then, the driving unit 30 can drive the robot 100 to move according to the moving control signal 41 to move forward or backward. As described above, the moving control signal is a move-forward signal 441 for driving the robot 100 to move forward or a move-backward signal 412 for driving the robot 100 to move backward. When receiving the move-forward signal 411, the driving unit 30 drives the robot 100 to move forward. On the contrary, when receiving the move-backward signal 412, the driving unit 30 drives the robot 100 to move backward. When the control unit 40 is connected to the detection unit 10 to receive the anti-drop-off precaution signal 12, the control unit 40 immediately stops transmitting the moving control signal 41 (no matter the moving control signal is move-forward signal 411 or the move-backward signal 412). However, when failing to receive the moving control signal 41, the driving unit 30 stops driving the robot 100. Besides, the control unit 40 can not only stop transmitting the moving control signal 41, but also can further transmit the anti-drop-off control signal 42 contrary to the original moving direction. For example, if the original moving control signal 41 is the move-forward signal 411, the control unit 40 transmits the anti-drop-off control signal 42 (i.e. the move-backward signal 412) after receiving the anti-drop-off precaution signal 12 in order to drive the robot 100 to be away from the area where the robot 100 may fall.

In addition to the above operations, the present invention further provides a first determine unit 50. The first determination unit 500 is connected to the detection unit 10 and the control unit 40 in order to receive the anti-drop-off precaution signal 12 and the moving control signal 41 (i.e. the move-forward signal 411). Besides, the first determination unit 50 is further connected to a first switching unit 60 and the first switching unit 60 is disposed between the control unit 40 and the driving unit 30. When receiving the anti-drop-off precaution signal 12, the first determination unit 50 determines whether the moving control signal 41 is received first (i.e. the move-forward signal). If receiving the anti-drop-off precaution signal 12 and the moving control signal 41 at the same time, the first determination unit 50 transmits a first interrupt signal 51 to the first switching unit 60 in order to interrupt the connection of the control unit 40 transmitting the moving control signal 41 to the driving unit 30 and then stop the control unit 40 transmitting the moving control signal 41 of driving the robot 100 to move in the direction which the robot 100 will drop off to the driving unit 30. More specifically, the anti-drop-off precaution signal 12 is a move-forward anti-drop-off precaution signal 121 or a move-backward anti-drop-off precaution signal 122. When the first determination unit 50 receives the move-forward anti-drop-off precaution signal 121 and simultaneously receives the move-forward signal 411 of driving the robot 100 to move in the direction which the robot 100 will drop off, it means that the control unit 40 receives the move-forward anti-drop-off precaution signal 121, but still keeps transmitting the move-forward signal 411 to the driving unit 30 without performing the corresponding operation. Therefore, the first determination unit 50 immediately generates the first interrupt signal 51 and transmits the first interrupt signal 51 to the first switching unit 60. Specifically, the position where the first switching unit 40 is disposed is the connection channel which the control unit 40 transmits the move-forward signal 411 to the driving unit 30. In this way, the first switching unit 60 can interrupt the connection of the control unit 40 transmitting the move-forward signal 411 to the driving unit 30 in order to stop the control unit 40 transmitting the move-forward signal 411 of driving the robot 100 to move in the direction which the robot 100 will drop off to the driving unit. Thus, the driving unit 30 will not perform the corresponding operation after receiving the move-forward signal 411 even if the control unit 40 keeps transmitting the move-forward signal 411. The above operation can force the driving unit 30 to drive the robot 100 to move forward (as shown in FIG. 1).

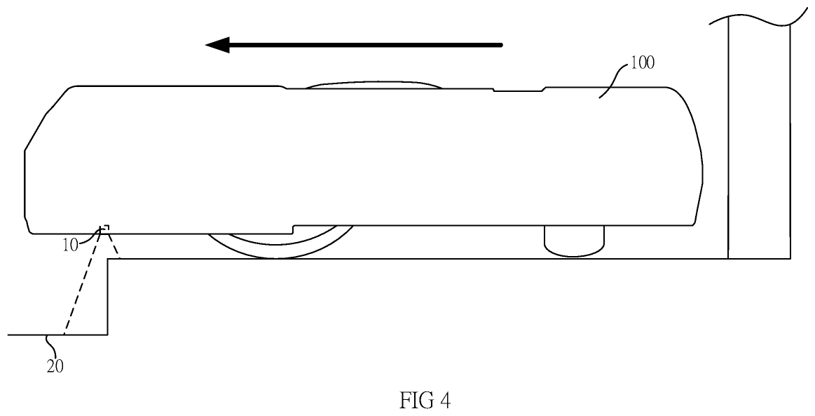

In addition, the first determination unit 50 can also be used to determine the signals about the directions of moving forward and backward. For example, when the control unit 40 transmits the move-backward signal 412 to the driving unit 30 to drive the robot 100 to move backward and the detection unit 10 detects that the robot 100 will drop off if keeping moving in the direction, the detection unit 10 transmits the move-backward anti-drop-off precaution signal 122 to the first determination unit 50. When receiving the move-backward anti-drop-off precaution signal 122, the first determination unit 50 determines that whether the moving control signal 41 (i.e. the move-backward signal 412) is received first. If receiving the move-backward anti-drop-off precaution signal 122 and the move-backward signal 412 of driving the robot 100 to move in the direction which the robot 100 will drop off at the same time, the first determination unit 50 transmits the first interrupt signal 51 to the first switching unit 60 so as to interrupt the connection of the control unit 40 transmitting the move-backward signal 412 to the driving unit 30 via the first switching unit 60 and then stop the control unit 40 transmitting the move-backward signal 412 of driving the robot 100 to move in the direction which the robot 100 will drop off to the driving unit 30 (as shown in FIG. 4).

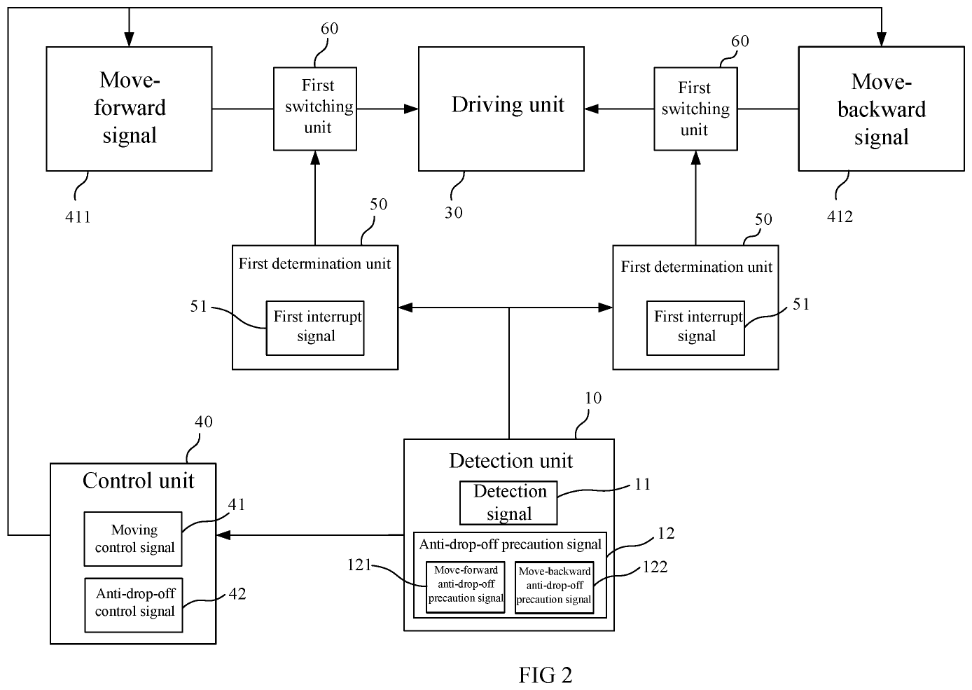

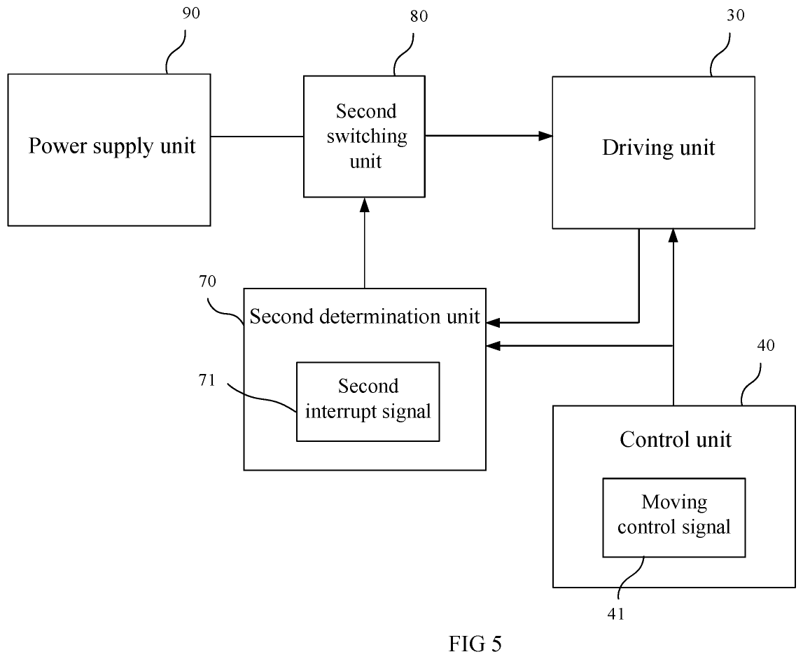

Please refer to FIG. 5, which is a system connection relation diagram of moving direction determination of the anti-drop-off system in accordance with the present invention; please also refer to FIG. 2. As shown in FIG. 5, when the control unit 40 transmits the moving control signal 41 to the driving unit 30 to drive the robot 100 to move forward or move backward via the driving unit 30, the second determination unit 70 also receives the moving control signal 41. More specifically, there is a second switching unit 80 disposed between the power supply unit 90 and the driving unit 30, and the second determination unit 70 is connected to the second switch unit 80. In addition, the driving unit 30 is connected to the power supply unit 90 installed inside the robot 100 via the second switching unit 80. Thus, when the driving unit 30 drives the robot to move forward or move backward, the second determination unit 70 receives the moving direction (e.g. the current signal) of the driving unit 30. Then, when the control unit 40 transmits the moving control signal 41 to the driving unit 30, the second determination unit 70 also receives the moving control signal 41 transmitted from the control unit 40. For example, when the driving unit 30 revolves clockwise to drive the robot 100 to move forward, the driving unit 30 receives the electrical energy from positive current to be driven to revolve clockwise. On the contrary, when the driving unit 30 revolves counterclockwise to drive the robot 100 to move backward, the driving unit 30 receives the electrical energy from negative current to be driven to revolve counterclockwise. In this way, when receiving the moving direction (e.g. the electrical energy of positive current or negative current) of the driving unit 30 and the moving control signal 41, the second determination unit 70 starts to determine whether the moving control signal 41 is consistent with the moving direction of the driving unit 30. If determining that the moving control signal 41 is not consistent with the moving direction of the driving unit 30, the second determination unit 70 transmits a second interrupt signal 71 to the second switching unit 80 in order to disconnect the driving unit 30 from the power supply unit 90 via the second switching unit 80.

The above disclosure is related to the detailed technical contents and inventive features thereof. Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An anti-drop-off system for robot, comprising:
a driving unit, disposed inside a robot to drive the robot to move;
a detection unit, disposed at one or both of a bottom and a peripheral of the robot, and configured to transmit a detection signal, wherein the detection signal is that the detection unit generates an anti-drop-off precaution signal when detecting the robot is going to drop off in a moving direction thereof;
a control unit, disposed inside the robot, connected to the detection unit and the driving unit, and configured to transmit a moving control signal to the driving unit to control the driving unit to drive the robot to move, wherein when the control unit receiving the anti-drop-off precaution signal, the control unit transmits an anti-drop-off control signal to the driving unit;
a first determination unit, disposed inside the robot and connected to the detection unit and the control unit, wherein when the first determination unit receiving the anti-drop-off precaution signal and the moving control signal for controlling the robot to move in a direction which the robot will drop off, the first determination transmits a first interrupt signal; and
a first switching unit, disposed inside the robot, between the control unit and the driving unit, and connected to the first determination unit, wherein when the first switching unit receiving the first interrupt signal, the first switching unit stops the control unit transmitting the moving control signal which drives the robot to move in the direction which the robot will drop off to the driving unit.

2. The anti-drop-off system for robot of claim 1, wherein the moving control signal is a move-forward signal for driving the robot to move forward and the detection unit is disposed in front of the robot; the anti-drop-off precaution signal is move-forward anti-drop-off precaution signal for preventing the robot moving forward and then dropping off; when the control unit receiving the move-forward anti-drop-off signal, the control unit stops transmitting the move-forward signal and then transmitting the moving control signal to the robot again, wherein the moving control signal is changed to be a move-backward signal for driving the robot to move backward.

3. The anti-drop-off system for robot of claim 2, wherein the moving control signal is a move-backward signal for driving the robot to move backward and the detection unit is disposed behind the robot; the anti-drop-off precaution signal is move-backward anti-drop-off precaution signal for preventing the robot moving backward and then dropping off; when the control unit receiving the move-backward anti-drop-off signal, the control unit stops transmitting the move-backward signal and then transmitting the moving control signal to the robot again, wherein the moving control signal is changed to be a move-forward signal for driving the robot to move forward.

4. The anti-drop-off system for robot of claim 3, further comprising:
a second determination unit, connected to the driving unit and the control unit, wherein when the second determination unit receiving a moving direction of the driving unit and the moving direction of the driving unit is different from a moving direction of the moving control signal, the second determination unit transmits a second interrupt signal; and
a second switching unit, wherein the driving unit is connected to a power supply unit disposed in the robot via the second switching unit, and the second switching unit is further connected to the second determination unit; when the second switching unit receiving the second interrupt signal, the second switching unit disconnects the driving unit from the power supply unit.
